(19) United States
(12) Patent Application Publication
(10) Pub. No.: US 2015/0372721 A1
(43) Pub. Date: Dec. 24, 2015

(54) Configuring User Equipment to Display Information Through a Cover Window

(71) Applicant: Sony Corporation, Tokyo (JP)

(72) Inventor: Henrik Bard, Lund (SE)

(21) Appl. No.: 14/311,470

(22) Filed: Jun. 23, 2014

(51) Int. Cl. H04B 5/00; H04W 4/00; H04B 1/3888

(52) U.S. Cl. CPC H04B 5/0075; H04B 1/3888; H04W 4/008; H04B 5/0031

(57) ABSTRACT

A cover apparatus for a user equipment includes a front surface connected to a user equipment and positioned to cover and prevent user viewing of a first portion of a display device. The front surface has a window providing user viewing of a second portion of the display device while the front surface covers the first portion of the display device. The cover apparatus further includes a NFC tag circuit configured to become powered by inductive coupling to signals emitted by a NFC reader within the user equipment to temporarily operate to transmit cover configuration data to the NFC reader within the user equipment. The cover configuration data provides information to an application executed by a processor of the user equipment to determine a location of the window in the front surface and to configure information displayed in the second portion of the display device.

### TECHNICAL FIELD

The present invention relates to wireless communication user equipment and, more particularly, to related accessories such as covers that are attachable to user equipment.

### BACKGROUND

Users desire to protect and personalize cell phones and other user equipment with covers. Cover manufacturers have responded to this need with a tremendous offering of covers having different shapes, sizes, and designs. Some covers provide a window that allows a user to see a portion of a display device of the user equipment while the display device is covered. The cover thereby provides protection and personalization for the user equipment while also enabling at least some limited functionality to be performed via the display device. Because of the tremendous number of types of covers and continuously evolving shapes and sizes of covers, a user equipment would not know whether an attached cover has a window and where that window effectively aligns with a portion of the display device.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

One embodiment of the present disclosure is directed to a cover apparatus for a user equipment. The cover apparatus includes a front surface connected to a user equipment and positioned to cover and prevent user viewing of a first portion of a display device of the user equipment. The front surface has a window providing user viewing of a second portion of the display device while the front surface covers and prevents user viewing of the first portion of the display device. The cover apparatus further includes a near field communication (NFC) tag circuit configured to become powered by inductive coupling to signals emitted by a NFC reader within the user equipment to temporarily operate to transmit cover configuration data to the NFC reader within the user equipment. The cover configuration data provides information to an application executed by a processor of the user equipment to determine a location of the window in the front surface and to configure information displayed in the second portion of the display device while the front surface covers and prevents user viewing of the first portion of the display device.

In a related embodiment, the cover configuration data provides information to the application executed by the processor of the user equipment to determine a size of the window, a shape of the window, and/or a location of the window in the front surface and to configure information displayed in the second portion of the display device while the front surface covers the first portion of the display device.

In a related embodiment, the front surface has another window providing user viewing of a third portion of the display device while the front surface covers and prevents user view of the first portion of the display device. The cover configuration data provides information to the application executed by the processor of the user equipment to determine a location of the other window in the front surface and to configure information displayed in the third portion of the display device while the front surface covers the first portion of the display device.

In a related embodiment, the cover apparatus includes side surfaces of the cover apparatus that grip side surfaces of the user equipment, and a back surface connected to the side surfaces. The NFC tag circuit is attached to the back surface. The front surface is connected to one of the side surfaces and/or the back surface of the cover apparatus through a hinge that allows movement of the front surface relative to the back surface from an open position that exposes for user viewing the first and second portions of the display device and a closed position that covers the first portion of the display device while the window provides user viewing of the second portion of the display device.

In a related embodiment, the side surfaces of the cover apparatus grip the side surfaces of the user equipment when the user equipment is slid between the side surfaces to a stored position. The NFC tag circuit is attached to the back surface and located to pass over the NFC reader of the user equipment to become temporarily powered to transmit the cover configuration data as the user equipment is slid between the side surfaces to the stored position.

In a related embodiment, the side surfaces are configured to receive a top of the user equipment to guide insertion of the user equipment to the stored position. The NFC tag circuit is attached adjacent to a bottom of the back surface to pass over the NFC reader located adjacent the top of the user equipment and become temporarily powered to transmit the cover configuration data and thereafter while the user equipment is in the stored position the NFC tag circuit is too remotely located from the NFC reader to become sufficiently powered by inductive coupling to signals emitted by the NFC reader to operate to transmit the cover configuration data.

In a related embodiment, the NFC tag circuit is configured to transmit a universal resource locator address as part of the cover configuration data that identifies a network node from which the user equipment can obtain the application which is configured to use the cover configuration data defining the location of the window in the front surface to configure information displayed in the second portion of the display device while the front surface covers the first portion of the display device.

In a related embodiment, the NFC tag circuit is configured to transmit a product code identifying the cover apparatus to enable the application executed by the processor of the user equipment to determine the location of the window in the front surface for configuring information displayed in the second portion of the display device while the front surface covers the first portion of the display device.

In a related embodiment, the cover apparatus further includes a conductive film on an adhesive layer. The conductive film extends across and electrically shorts an antenna of the NFC tag circuit to prevent the NFC tag circuit from being sufficiently powered by inductive coupling to signals emitted by the NFC reader to operate to transmit the cover configuration data. The conductive film is removable by a user to enable the NFC tag circuit to be sufficiently powered by inductive coupling to signals emitted by the NFC reader to operate to transmit the cover configuration data, and is re-attachable to the antenna by the user to prevent subsequent retransmission of the cover configuration data and associated interference with the NFC reader attempting to read other NFC tag circuits.

In a related embodiment, the NFC tag circuit includes a charging circuit that accumulates power received through the inductive coupling to the NFC reader within the user equipment. The cover apparatus further includes a user input interface powered by the charging circuit, user actuation of the user input interface causes the NFC tag circuit to be powered by the charging circuit to transmit a corresponding data signal to the NFC reader within the user equipment.

Some other embodiments are directed to a user equipment that includes a housing, a display device, a NFC reader circuit, a processor, and a memory. The housing attaches to a cover apparatus. The display device forms at least a portion of a front surface of the housing. The NFC reader circuit is configured to scan a NFC tag circuit of the cover apparatus through inductive coupling to obtain cover configuration data. The processor is coupled to the NFC reader circuit and the display device. The memory is coupled to the processor and includes computer readable program code that when executed by the processor causes the processor to perform operations. The operations include determining from the cover configuration data a location of a window in the cover apparatus that provides user viewing of a second portion of the display device while a first portion of the display device is covered by the cover apparatus preventing user viewing of the first portion of the display device, and configuring information based on the determined location of the window in the cover apparatus for display in the second portion of the display device while the cover apparatus covers and prevents user viewing of the first portion of the display device.

In a related embodiment, the operations further include determining from the cover configuration data a size of the window, a shape, and/or location of the window in the cover apparatus, and configuring the information based on the determined size, shape, and/or location of the window in the cover apparatus for display in the second portion of the display device while the front surface covers the first portion of the display device.

In a related embodiment, the operations further include displaying information only within the second portion of the display device while the cover apparatus covers the first portion of the display device.

In a related embodiment, the operations further include selecting a group of applications that are configured to display information within the second portion of the display device while the cover apparatus covers the first portion of the display device, and displaying members of the selected group of applications to a user for selective execution.

In a related embodiment, the operations further include determining from the cover configuration data a location of another window in the cover apparatus that provides user viewing of a third portion of the display device while the first portion of the display device is covered by the cover apparatus preventing user viewing of the first portion of the display device, and configuring other information based on the determined location of the other window in the cover apparatus for display in the third portion of the display device while the cover apparatus covers the first portion of the display device.

In a related embodiment, the operations further include identifying a universal resource locator address as part of the cover configuration data, obtaining the application from a network node identified by the universal resource locator address, and executing the application to use the cover configuration data defining the location of the window in the front surface to configure information displayed in the second portion of the display device while the front surface covers the first portion of the display device.

In a related embodiment, the operations further include obtaining a product code from the cover configuration data which identifies the cover apparatus, and determining the location of the window in the front surface based on the product code.

In a related embodiment, the display device includes a touch sensitive interface configured to output a location where a user touched the display device. The operations further include calibrating the determined location of the window in the cover apparatus based on sensing at least one location of a user touch within the second portion of the display device.

In a related embodiment, the operations further include calibrating the determined location of the window in the cover apparatus to not exclude any of a plurality of locations of user touches within the second portion of the display device.

In a related embodiment, the display device includes a touch sensitive interface configured to output a location where a user touched the display device. The operations further include causing an application, which is generating the information for display in the second portion of the display device, to ignore any touch locations from the touch sensitive interface that are outside the second portion of the display device while the cover apparatus covers the first portion of the display device.

In a related embodiment, the user equipment further includes a camera device. The operations further include operating the camera device to scan an optical code, and determine at least a portion of the cover configuration data from the optical code.

### BRIEF DESCRIPTION OF THE DRAWINGS

Aspects of the present disclosure are illustrated by way of example and are not limited by the accompanying drawings. In the drawings:

FIG. 1 illustrates a user equipment that is attached to a cover apparatus that provides cover configuration data to the user equipment according to some embodiments;

FIG. 2 is a block diagram of a UE having a NFC reader and a cover apparatus having a NFC tag circuit, in which the UE's NFC reader scans cover configuration data from the cover apparatus' NFC tag circuit while the UE is slid to a stored position, according to some embodiments;

FIG. 3 illustrates relative locations of the NFC reader and the NFC tag circuit while the UE is attached in a stored position to the cover apparatus of FIG. 2 according to some embodiments;

FIG. 4 is a block diagram of components of a cover apparatus and a user equipment according to some embodiments;

FIG. 5 illustrates a data flow diagram and flowchart of operations that can be performed by a NFC tag circuit of a cover apparatus, a user equipment, and an application server according to some embodiments;

FIGS. 6-10 illustrate flowcharts of operations that may be performed by the user equipment in accordance with some embodiments; and

FIG. 11 illustrates a removable conductive sticker configured to short-circuit one or more components of the NFC tag circuit of the cover apparatus to selectively prevent activation of the NFC tag circuit according to some embodiments.

### DETAILED DESCRIPTION

In the following detailed description, numerous specific details are set forth in order to provide a thorough understanding of embodiments of the invention. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

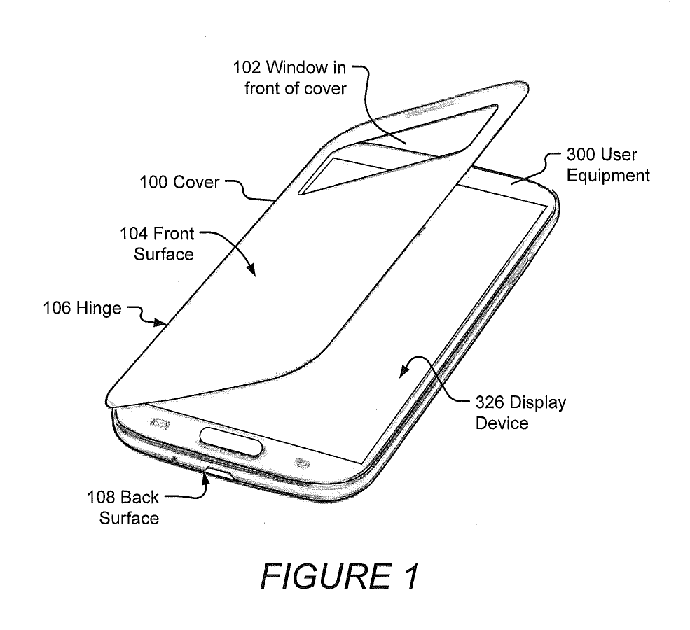

Various embodiments of the present disclosure are directed to a cover apparatus that is attachable to a user equipment (“UE”) and which automatically configures the UE to display information based on location of a window in the cover apparatus. FIG. 1 illustrates a cover apparatus 100 (also referred to as a “cover” for brevity) that is configured according to some embodiments for use with a UE 300. The cover 100 includes side surfaces that grip side surfaces of the UE 300, a back surface 108 that covers at least a portion of a back surface of the UE 300, and a front surface 104 that is connected to the side surfaces and/or the back surface 108 by a hinge 106 (e.g., a flexible extension of the front surface 104). The hinge 106 allows movement of the front surface 104 relative to the back surface 108 from an open position that exposes for user viewing a display device 326 of the UE 300 and a closed position that covers a first portion of the display device 326 to prevent user viewing of the first portion of the display device 326. The front surface 104 has a window 102 that provides (allows) user viewing of a second portion of the display device 326 while the front surface 104 covers and prevents user viewing of the first portion of the display device 326.

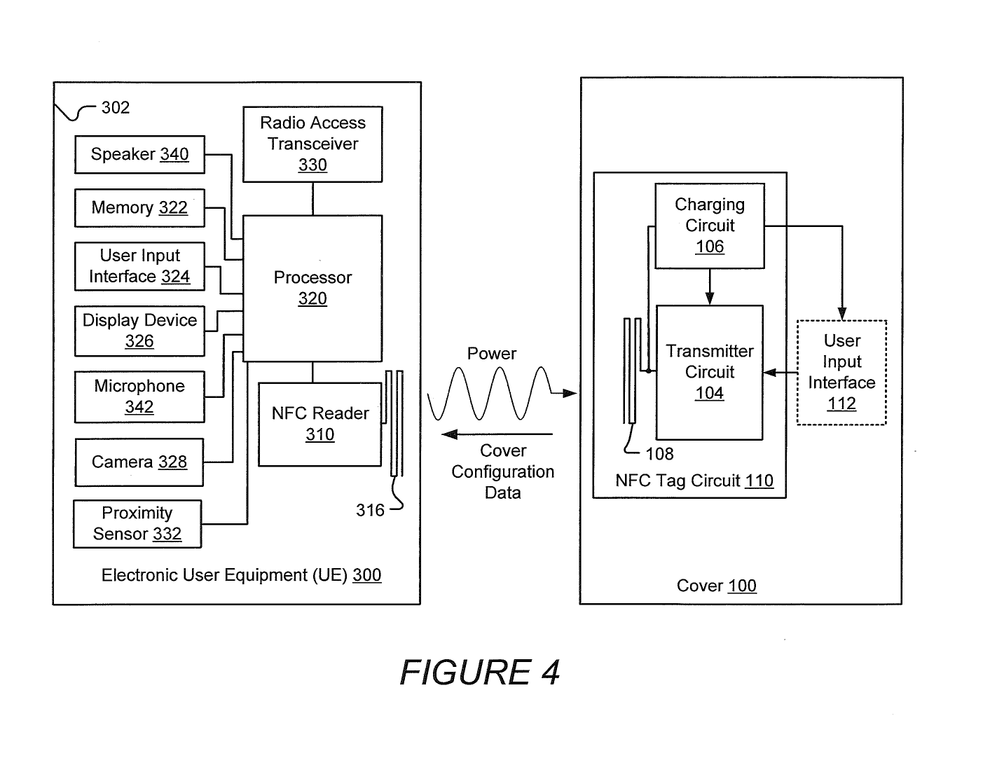

In accordance with some embodiments disclosed herein, the cover 100 further includes a near field communication (NFC) tag circuit that is configured to become powered by inductive coupling to signals emitted by a NFC reader within the UE 300 to temporarily operate to transmit cover configuration data to the NFC reader within the UE 300. The cover configuration data provides information to an application executed by a processor 320 (FIG. 4) of the UE 300 to determine a location of the window 102 in the front surface 104 and to configure information displayed in the second portion of the display device 326 while the front surface 104 covers and prevents user viewing of the first portion of the display device 326.

Although some embodiments of NFC tag circuits are described as being attached to a cover related to which they communicate configuration information, in some other embodiments the NFC tag circuit is separate from the cover. For example, the NFC tag circuit may be commonly packaged with the cover but separate therefrom, such as by being attached to product packaging instead of to the cover.

The UE 300 determines from the cover configuration data a location of the window 102 in the cover 100 that provides user viewing of a second portion of the display device 326 while a first portion of the display device 326 is covered by the cover 100 preventing user viewing of the first portion of the display device 326, and configures information based on the determined location of the window 102 in the cover 100 for display in the second portion of the display device 326 while the cover 100 covers and prevents user viewing of the first portion of the display device 326.

In this manner, the UE 300 can automatically determine a location of the window 102 and configure how it displays information for a user's viewing of information through the window 102. Example information that may be generated by the UE 300 and displayed in the first portion of the display device 326 for viewing through the window 102 may include, but is not limited to, time of day, date, content of a received message, phone number of an incoming call, battery life status, a picture, user selectable actions (e.g., menu items).

As will be explained in further detail below, the cover configuration data may identify a size, shape, and/or location of the window 102. The display device 326 may include a touch sensitive interface, and the UE 300 can use the cover configuration data to determine the location of the first portion of the display device 326 that is aligned with the window 102 and in which user touch selections should be processed.

The UE 300 can further use the cover configuration data to determine a location of the second portion of the display device 326 that is covered by the front surface 104 and in which any touch selections should be ignored by applications executed by the UE 300.

The cover configuration data may identify a relative location of the cover's window from a defined point on the cover. The UE 300 can translate the identified location of the window from the defined point on the cover to a relative location of the window from a corresponding defined point on the UE 300. For example, the cover configuration data may identify that the window has a corner located X mm and Y mm distant from a top left corner of the cover. The UE 300 can know the location of the display device 326 from the upper left corner of its housing, and can translate the X mm and Y mm location of the window corner to a corresponding location on the display device 326. The UE 300 can use the cover configuration data defining a size (e.g., length of A mm by height of B mm) or distance from each corner of the window relative a defined point of the cover to determine which part of the display device 326 is aligned with the window.

Although various embodiments are described in the context of a single window 102 in the front surface 104, the embodiments disclosed herein can be extended to determining the location of a plural number of windows in the front surface 104 based on cover configuration data provided by the cover 100, and responsively operating the UE 300 to display information within portions of the display device 326 that are aligned with or otherwise positioned relative to corresponding locations of each of the plural number of windows.

Moreover, although various embodiments are described in the context of the cover 100 including a NFC tag circuit 110 that transmits the cover configuration data to the NFC reader 310 of the UE 300, in some additional or other embodiments the cover 100 displays an optical code (e.g., a QR Code sticker attached to or printed on the cover 100) that can be scanned by a camera device in the UE 300. The optical code can encode information that includes at least a portion of the cover configuration data disclosed herein. Accordingly, the UE 300 may use a camera device to optically scan the optical code to determine at least a portion or all of the cover configuration data and perform operations disclosed herein using the determined cover configuration data.

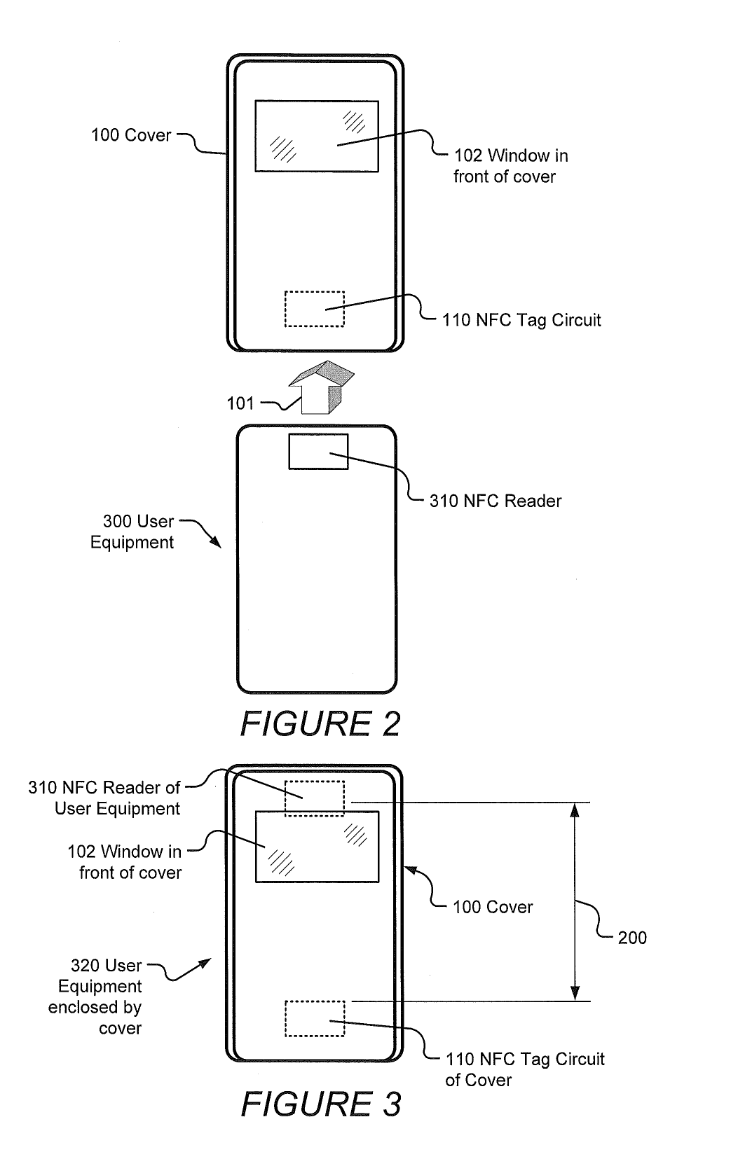

FIG. 2 is a block diagram of a UE 300 having a NFC reader 310 and a cover 100 having a NFC tag circuit 110. The cover 100 is configured so that the UE's NFC reader 310 scans the cover apparatus' NFC tag circuit 110 while the UE 300 is slid along direction 101 to a stored position, according to some embodiments. FIG. 3 illustrates relative locations of the NFC reader 310 and the NFC tag circuit 110 while the UE 300 is attached in a stored position to the cover 100 of FIG. 2 according to some embodiments. Although some embodiments of the cover 100 are described as being configured to slide-on the UE 300, other embodiments of covers may snap on, adhesively connect to, or otherwise maintain contact with the UE 300.

In one embodiment, the side surfaces extend along at least two sides of the cover apparatus 100 rising away from the back surface 108 to form a central recessed surface area that can grip the UE 300 slid toward the stored position where it is retained until removed by a user.

The cover 100 may function to protect a front and/or back surface of the UE 300 and/or as a stand, such as a handsfree phone accessory, that supports and holds the UE 300 in a defined orientation. The UE 300 may be a cellular phone, a tablet computer, a palmtop computer, a mobile music/video player, or any other electronic device having a display device.

The cover 100 has a NFC tag circuit 110 may reside on a flexible substrate (e.g., adhesive sticker) that can be attached to the back surface 108 or the front surface 104, and may be at least partially disposed within or entirely within the back surface 108 or the front surface 104. Depending upon the proximity and electrical configuration of the NFC tag circuit 110 of the cover 100 and the NFC reader 310 of the UE 300 310 while the UE 300 is attached in the stored position to the cover 100, the NFC tag circuit 110 may interfere with the ability of the UE NFC reader 310 to scan a NFC circuit of a targeted device (e.g., a point of sale credit card processing terminal, a NFC tag on a product, etc.) which a user is attempting to scan using the UE 300.

For example, absent use of various embodiments disclosed herein, the NFC tag circuit 110 could be positioned between the UE NFC reader 310 and the NFC circuit of the targeted device, and located much closer to the UE NFC reader 310 than the NFC circuit of the targeted device. Transmissions from the NFC tag circuit 110 may thereby undesirably interfere (collide) with transmissions from the targeted device, and prevent reliable receipt by the UE 300 of data from the NFC circuit of the targeted device.

However, in accordance with some embodiments disclosed herein, the NFC tag circuit 110 is attached at a location on the front surface 104 or back surface 108 and configured to be powered by inductive coupling to signals emitted by the other NFC reader 310 within the UE 300 to temporarily operate to transmit data to the UE NFC reader 310 as the NFC tag circuit 110 passes over the UE NFC reader 310 while the UE 300 is being slid into the cover 100 before reaching the stored position. The UE 300 may be configured to alternatively activate application functionality that utilizes the cover configuration data to control how information is displayed through the cover window 102 responsive to one scan of the NFC tag circuit 110 and then deactivate that application functionality responsive to a subsequent scan of the NFC tag circuit 110 (e.g., automatically enable the functionality when the UE 300 is inserted into the cover 100 and disable the functionality when the UE 300 is removed from the cover 100).

In some further embodiments, the NFC tag circuit 110 becomes powered by inductive coupling to signals emitted by the UE NFC reader 310 to temporarily operate to transmit data to the UE NFC reader 310 as the NFC tag circuit 110 passes over the UE NFC reader 310 while the housing 102 is being slid off the UE 300. Furthermore, while the housing 102 is in the stored position relative to the UE 300, the NFC tag circuit 110 is inhibited or prevented from transmitting data to the UE NFC reader 310 irrespective of whether the UE NFC reader 310 is emitting signals to attempt to provide inductive coupling to the NFC tag circuit 110.

Referring to the embodiment of FIG. 3, while the UE 300 is in the stored position relative to the cover 100, the NFC tag circuit 110 is too remotely located from the UE NFC reader 310 to be sufficiently powered by any inductive coupling to signals emitted by the UE NFC reader 310 to operate the transmit data, according to one embodiment. For example, the cover 100 has a top that is adjacent an ear speaker 340 (FIG. 4) of the UE 300 and a bottom that is adjacent a microphone 342 (FIG. 4) of the UE 300 while the cover 100 is in the stored position relative to the UE 300. The NFC tag circuit 110 is located adjacent the bottom of the housing 102 and spaced apart by distance 200 to be remote from the UE NFC reader 310 located adjacent the ear speaker of the UE 300. A location where the NFC tag circuit 110 is attached to the front surface 104 or back surface 108 can be selected to provide sufficient communication isolation between the NFC tag circuit 110 and NFC reader 310 to inhibit or prevent data transmission by the NFC tag circuit 110 while the UE 300 attached in the stored position in the cover 100.

FIG. 4 is a block diagram of components of the cover 100 and the UE 300 that are connectable and configured to operate according to some embodiments. The UE 300 can include a housing 302, a processor circuit 320, a radio access transceiver 330, a NFC reader 310, a memory device(s) 322, a display device 326, a user input interface 324 (e.g., touch sensitive interface for the display device 326, keypad/keyboard, button(s)/switch(es), etc.), a camera 328, a speaker 340, and a microphone 342.

The UE 300 may include a proximity sensor 332 that is configured to sense when the display device 326 is covered by an object, such as the front surface 104 of the cover. The proximity sensor 332 may sense a magnet mounted within the front surface 104 to determine when the front surface 104 is covering the display device 326. The proximity sensor 332 may operate in combination with a touch interface to sense when a threshold number of simultaneous touch locations are occurring on the display device 326 to indicate that the display device 326 is covered. The proximity sensor 332 may operate in combination with the camera 328 to sense when the camera 328 is covered by the front surface 104 of the cover 100 (i.e., when the camera 328 is a front facing camera).

The radio access transceiver 330 may include, but is not limited to, a LTE or other cellular transceiver, Bluetooth transceiver, WiFi transceiver, WiMax transceiver, or other communication transceiver is configured to communicate with a network node of a telecommunications system. The processor 320 may include one or more data processing circuits, such as a general purpose and/or special purpose processor (e.g., microprocessor and/or digital signal processor). The processor 320 is configured to execute computer program instructions of one or more applications residing in the memory 322, described below as a computer readable medium, to perform at least some of the operations and methods described herein as being performed by a UE.

The cover 100 includes a NFC tag circuit 110 that can be powered by and communicate with the UE NFC reader 310 using short-range high frequency wireless communication technology which enables the exchange of data between devices over about a 10 cm distance, although the tag circuit 110 and the NFC reader 310 are not limited to operating in at any defined range. The communication protocol and operation can be an extension of the ISO 14443 proximity-card standard (contactless card, RFID) and can be specified in the ECMA-340 and ISO/IEC 18092 technology standards. Some embodiments of the NFC tag circuit 110 and the NFC reader 310 may communicate using existing ISO 14443 smartcards and readers and can thereby be compatible with existing contactless communication infrastructure. The NFC tag circuit 110 and NFC reader 310 are limited to any particular protocol, instead they may operate using any short-range communication technology which may include, but is not limited to, RFID, Bluetooth, etc.

The tag circuit 110 and the NFC reader 310 may communicate via magnetic field induction. A loop antenna 316 connected to the NFC reader 310 and a loop antenna 108 of the NFC tag circuit 110 are placed in close proximity to each other within the other's antenna near field, thereby effectively forming an air-core transformer. Some embodiments of the tag circuit 110 and the NFC reader 310 can transmit within the globally available and unlicensed radio frequency ISM band of 13.56 MHz, with a bandwidth of almost 2 MHz. Some embodiments of the tag circuit 110 and the NFC reader 310 can support data rates of 106, 212, or 424 kbit/s using a modified Miller coding or Manchester coding to encode and decode communicated data.

The NFC tag circuit 110 can be configured to operate in a passive communication mode, because the cover 100 does not have its own power source. In contrast, the UE NFC reader 310 can be configured to operate in an active communication mode powered by a rechargeable battery of the UE 300. When operating in the passive communication mode, the UE NFC reader 310 provides a carrier field and the NFC tag circuit 110 answers by modulating the carrier field. In this mode, the NFC tag circuit 110 generates its operating power from the NFC reader 310 provided electromagnetic field, thus making the NFC tag circuit 110 a transponder.

In one embodiment, the NFC tag circuit 110 includes a charging circuit 106 that accumulates power received through the antenna 108 and inductive coupling to the UE NFC reader 310, and provides power to a transmitter circuit 104. The transmitter circuit 104 transmits the cover configuration data through the antenna 108 to the UE NFC reader 310 using the power from the charging circuit 106.

In a further embodiment, the cover 100 further includes a user input interface 112 powered by the charging circuit 106. User actuation of the user input interface 112 causes the transmitter circuit 104 to be powered by the charging circuit 106 to transmit a corresponding data signal to the NFC reader 310 within the UE 300. The user input interface 112 may, for example, include a plurality of user selectable buttons (e.g. buttons located on the front surface 104) that are powered by the charging circuit 106. User actuation of selected ones of the user selectable buttons causes the transmitter circuit 104 to be powered by the charging circuit 106 to transmit a corresponding selected one of a plurality different input data signals to the NFC reader 310 within the UE 300.

In one embodiment, the NFC tag circuit 110 is configured to delay transmission of data to the UE NFC reader 310 until expiration of a defined delay time after the NFC tag circuit 110 becomes sufficiently powered on to operate. Thus, for example, the transmitter circuit 104 can be configured to delay a defined time after it becomes powered on by the charging circuit 106 (through inductive coupling to the UE NFC reader 310) before transmitting data through the antenna 108. Delaying the NFC tag circuit's 110 data transmission may help avoid interfering with the ability of the UE NFC reader 310 to communicate with a NFC circuit of a targeted device (e.g., which is configured to transmit data immediately upon being powering on) which a user is attempting to scan through the UE 300.

After an initial receipt and use of information from the NFC tag circuit 110 by an application executed by the UE, the application may be configured to subsequently ignore information from the NFC tag circuit 110 to avoid interference with communications between the NFC reader 310 of the UE 300 and other NFC devices.

Referring to FIG. 11, the NFC tag circuit 110 can be selectively enabled and disabled using a removable conductive film 1100 (e.g., a sticker) with an adhesive layer that attaches to and extends across at least a portion of the NFC tag circuit 110. The NFC tag circuit 110 may be selectively enabled by having a user remove the conductive film 1100 to allow the NFC reader 310 of the UE 300 to scan the cover configuration data therefrom, and can be selectively disabled by having the user replace the conductive film to extend across at least a portion of the NFC tag circuit 110. The NFC tag circuit 110 may be disabled by the removable conductive film electrically shorting an antenna 108 of the NFC tag circuit 110 to prevent the NFC tag circuit 110 from being sufficiently powered by inductive coupling to signals emitted by the NFC reader 310 of the UE 300 to operate to transmit the cover configuration data. The conductive film 1100 may include a conductive (e.g., metal) mesh wiring, a conductive (e.g., metal) layer, or conductive line. The conductive film 1100 may electrically connect two locations on the antenna 108 to render the antenna 108 inoperable for receiving sufficient power from NFC signals from a NFC reader device to prevent operational powering of the NFC tag circuit 110. In this manner, the conductive film 1100 can disable the NFC tag circuit 110 to avoid interfering with the ability of the UE NFC reader 310 to communicate with a NFC circuit of a targeted device (e.g., which is configured to transmit data immediately upon being powering on) which a user is attempting to communicate with through the UE 300.

In another embodiment, the NFC tag circuit 110 includes a switch that a user can actuate to selectively disable operation of the NFC tag circuit 110. For example, the switch may selectively electrically isolate the antenna 108 from the transmitter 104 and/or may selectively electrically short the antenna 108.

In another embodiment, a user may be instructed to remove (e.g., peel off) the NFC tag circuit 110 after the UE NFC reader 310 has scanned the cover configuration data to, for example, prevent interference with subsequent operation of the UE NFC reader 310 when attempting to scan other NFC tag circuits.

### Configuring Display of Information Through a Window of a Cover

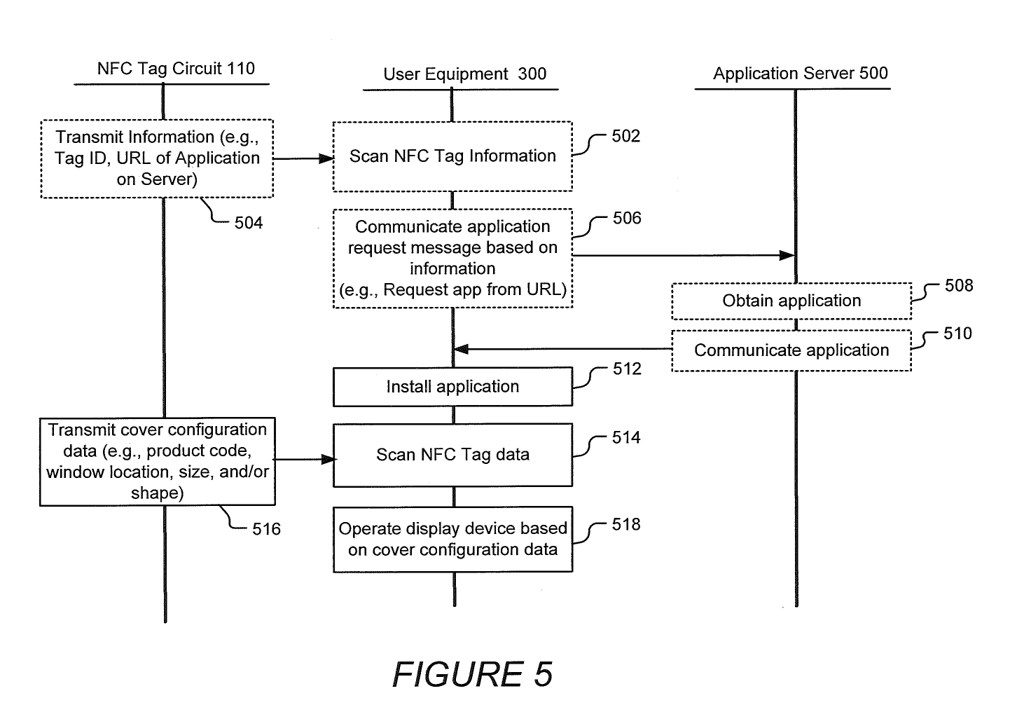

FIG. 5 illustrates a data flow diagram and flowchart of operations that can be performed by a NFC tag circuit 110 of a cover 100, a UE 300, and an application server 500 to configure how the UE 300 displays information through a window in a cover according to some embodiments.

In a first optional group of operations shown in blocks 502-510, the NFC tag circuit 110 transmits information, which can include a universal resource locator (URL) address of an application on the application server 500 or other network node, and the UE 300 obtains an application from the application server 500 or other network node based on the information. More particularly in the example embodiment, UE 300 is operated to scan (block 502) the NFC tag circuit 110 to operationally power the NFC tag circuit 110 to cause transmission (block 504) of information. The information includes a URL address of an application on the application server 500, and may include a tag ID that identifies the cover 100.

The UE 300 communicates (block 506) an application request message based on the information from the NFC tag circuit 110. The application request message requests the application from the application server 500 identified by the URL address. The application server 500 may operate as an application store having applications that can be downloaded to UEs. The application server 500 obtains (block 508) the application from mass storage, and communicates (block 510) the application to the UE 300.

The UE 300 installs (block 512) and executes the application. Features of the application may be set, changed, or defined based on the information from the NFC tag circuit 110.

The application may alternatively be installed by a manufacturer or by a user in a conventional manner from the application server 504 or an application store.

In a second group of operations, the UE 300 executes the application to scan (block 514) the NFC tag circuit 110 to operationally power the NFC tag circuit 110 to cause transmission (block 516) of cover configuration data, which may include a product code and/or information identifying a location of a window (e.g., window 102) in the cover 100. The information identifying a location of the window may further identify a size of the window, a shape of the window, and/or a location of the window.

The UE 300 further executes application to operate (block 518) the display device 326 based on the cover configuration data.

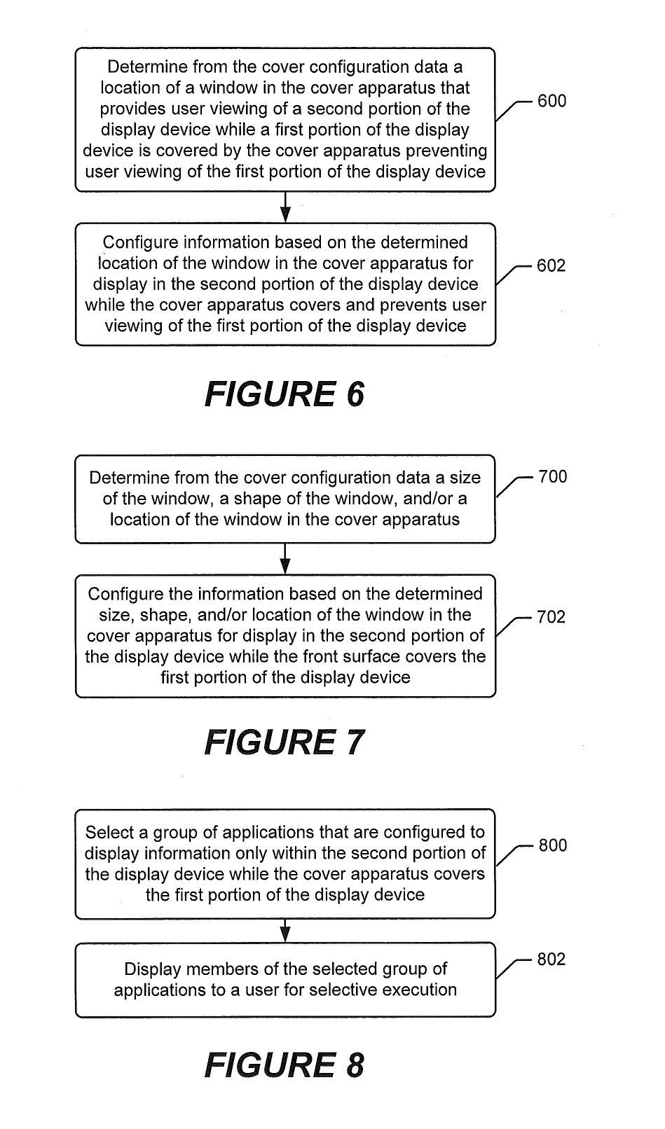

FIGS. 6-10 illustrate flowcharts of operations that may be performed by the UE 300 and, more particularly, by the processor 320 (FIG. 4) executing computer readable program code in the memory 322, to perform operations using the cover configuration data in accordance with some embodiments.

Referring to FIG. 6, the operations include determining (block 600) from the cover configuration data a location of a window 102 in the cover 100 that provides user viewing of a second portion of the display device 326 while a first portion of the display device 326 is covered by the cover 100 preventing user viewing of the first portion of the display device 326. The operations further include configuring (block 602) information based on the determined location of the window 102 in the cover 100 for display in the second portion of the display device 326 while the cover 100 covers and prevents user viewing of the first portion of the display device 326.

The processor 320 may selectively perform the operations of FIG. 6 only while the front surface 104 of the cover 100 covers the display device 326. The processor 320 can cease performance of the operations of FIG. 6 when the front surface 104 is moved away from the display device 326 to expose the entire display device 326 to user viewing. The processor 320 may respond to a signal from the proximity sensor 332 to determine when the front surface 104 of the cover 100 cover the display device 326.

Referring to FIG. 7, the operations may further include determining (block 700) from the cover configuration data a size of the window 102, a shape of the window 102, and/or a location of the window 102 in the cover 100. The cover configuration data may define the size, shape, and/or location of the window 102 using a scalable vector graphics (SVG) markup language and/or another syntax known to the application executed by the processor 320 of the UE 300. For example, the cover configuration data may define the size, shape, and/or location of the window 102 as a rectangle defined in the cover configuration data as rect(x,y,w,h), a circle describe defined in the cover configuration data as circle (x,y,r), and/or a path defined in the cover configuration data by path(x,y,x1,x1,x2,x2, . . . ), where the function parameters are values defined to indicate the size, shape, and/or location of the window 102. The operations further include configuring (block 702) the information based on the determined size, shape, and/or location of the window 102 in the cover 100 for display in the second portion of the display device 326 while the front surface 104 covers the first portion of the display device 326.

The operations may include displaying information only within the second portion of the display device 326 while the front surface 104 of the cover 100 covers the first portion of the display device 326. The processor 320 may therefore turn-off the display device 326 (e.g., an OLED display) outside the second portion of the display device 326 to conserve power. When the UE 300 wakes form a sleep or other reduced power state while the cover 100 covers the first portion of the display device 326, the processor 320 may turn-on and display information only within the second part of the display device 326 that is exposed for viewing through the window 102.

Referring to FIG. 8, the operations may further include selecting (block 800) a group of applications that are configured to display information within the second portion of the display device 326 (and which may be configured to only display information within the second portion) while the cover 100 covers the first portion of the display device 326. The operations further include displaying (block 802) members of the selected group of applications to a user via the display device 326 for selective execution. The group of applications may include applications that display a time of day, a date, content of a received message, a phone number of an incoming call, battery life status, a picture, and/or user selectable actions (e.g., menu items) within the second portion of the display device 326 while the cover 100 covers the first portion of the display device 326. The second portion of the display device 326 may operate to sense user touch selections therein while the cover 100 covers the first portion of the display device 326, and provide responsive commands to associated executing application(s).

As explained above, the cover 100 may include a plurality of windows. The cover configuration data may indicate a location, and may further indicate a size, shape, and/or location, of each of the windows. Accordingly, further to the operations of FIG. 6, the operations can include determining from the cover configuration data a location of another window in the cover 100 that provides user viewing of a third portion of the display device 326 while the first portion of the display device 326 is covered by the cover 100 preventing user viewing of the first portion of the display device 326. The operations include configuring other information based on the determined location of the other window in the cover 100 for display in the third portion of the display device 326 while the cover 100 covers the first portion of the display device 326.

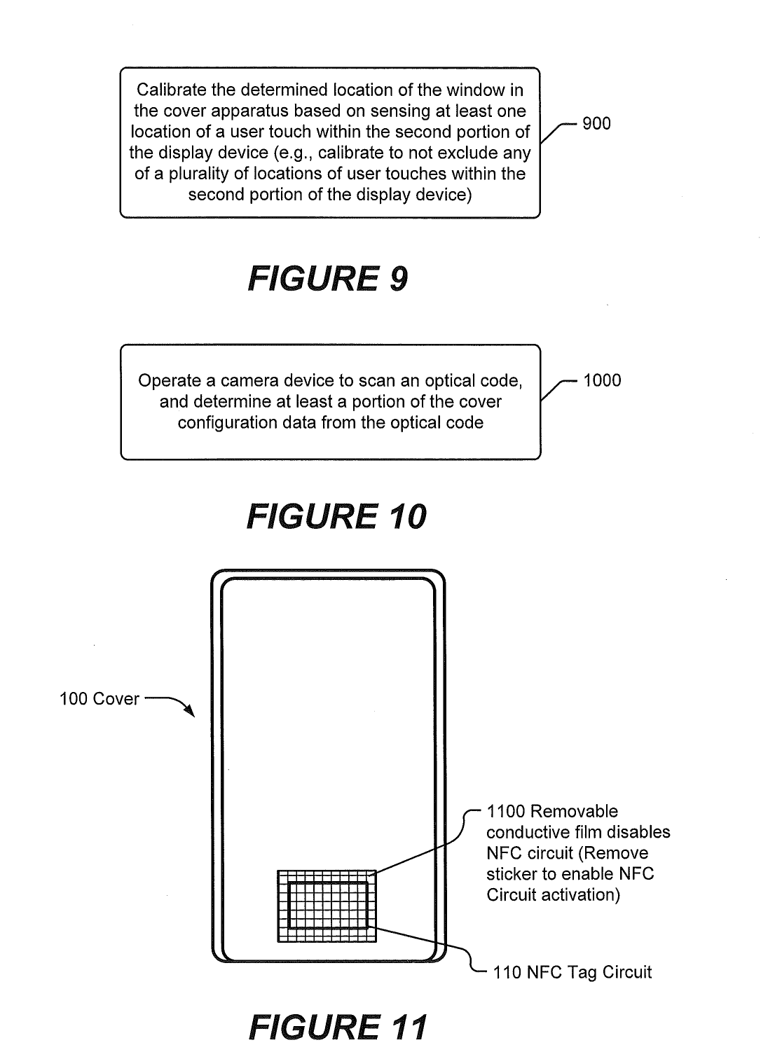

As explained above, the display device 326 may include a touch sensitive interface configured to output a location where a user touched the display device 326. Referring to FIG. 9, the operations may include calibrating the determined location of the window in the cover 100 based on sensing at least one location of a user touch within the second portion of the display device 326. The determined location may, for example, be calibrated (adjusted) based on a user touching the display device 326 at location aligned with a center of the window 102, such as responsive to an instruction displayed in the second portion of the display device 326.

The determined location of the window in the cover 100 may be calibrated to not exclude any of a plurality of locations of user touches within the second portion of the display device 326. Thus, for example, the location of the window may be calibrated (adjusted) as the user touches locations around a periphery of the window 102. A user may, for example, run a finger along edges of the window 102 to trace a location, size, and shape of the window 102 on the second portion of the display device 326.

When the display device 326 includes a touch sensitive interface configured to output a location where a user touched the display device 326, the operations may include causing an application, which is generating the information for display in the second portion of the display device 326, to ignore any touch locations from the touch sensitive interface that are outside the second portion of the display device 326 while the cover 100 (e.g., the front surface 104) covers the first portion of the display device 326. Thus, while the display device 326 is covered (e.g., determined responsive to a signal from the proximity sensor 332) the application can ignore touches occurring at locations outside the second portion of the display device 326. In sharp contrast, while the display device 326 is uncovered (e.g., determined responsive to a signal from the proximity sensor 332) the application can receive and respond to at least some touches occurring at locations outside the second portion of the display device 326.

### Further Definitions and Embodiments

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When a node is referred to as being “connected”, “coupled”, “responsive”, or variants thereof to another node, it can be directly connected, coupled, or responsive to the other node or intervening nodes may be present. In contrast, when an node is referred to as being “directly connected”, “directly coupled”, “directly responsive”, or variants thereof to another node, there are no intervening nodes present. Like numbers refer to like nodes throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A cover apparatus for a user equipment comprising:
a front surface connected to a user equipment and positioned to cover and prevent user viewing of a first portion of a display device of the user equipment, the front surface having a window providing user viewing of a second portion of the display device while the front surface covers and prevents user viewing of the first portion of the display device; and
a near field communication (NFC) tag circuit configured to become powered by inductive coupling to signals emitted by a NFC reader within the user equipment to temporarily operate to transmit cover configuration data to the NFC reader within the user equipment, the cover configuration data providing information to an application executed by a processor of the user equipment to determine a location of the window in the front surface and to configure information displayed in the second portion of the display device while the front surface covers and prevents user viewing of the first portion of the display device.

2. The cover apparatus of claim 1, wherein:
the cover configuration data provides information to the application executed by the processor of the user equipment to determine a size of the window, a shape of the window, and/or a location of the window in the front surface and to configure information displayed in the second portion of the display device while the front surface covers the first portion of the display device.

3. The cover apparatus of claim 1, wherein:
the cover configuration data identifies information to the application executed by the processor of the user equipment to determine a size of the window, a shape of the window, and/or a location of the window in the front surface and to configure information displayed in the second portion of the display device while the front surface covers the first portion of the display device.

4. The cover apparatus of claim 1, wherein:
the front surface has another window providing user viewing of a third portion of the display device while the front surface covers and prevents user view of the first portion of the display device; and
the cover configuration data provides information to the application executed by the processor of the user equipment to determine a location of the other window in the front surface and to configure information displayed in the third portion of the display device while the front surface covers the first portion of the display device.

5. The cover apparatus of claim 1, further comprising
side surfaces of the cover apparatus that grip side surfaces of the user equipment; and
a back surface connected to the side surfaces, wherein the NFC tag circuit is attached to the back surface,
wherein the front surface is connected to one of the side surfaces and/or the back surface of the cover apparatus through a hinge that allows movement of the front surface relative to the back surface from an open position that exposes for user viewing the first and second portions of the display device and a closed position that covers the first portion of the display device while the window provides user viewing of the second portion of the display device.

6. The cover apparatus of claim 5, wherein:
the side surfaces of the cover apparatus grip the side surfaces of the user equipment when the user equipment is slid between the side surfaces to a stored position; and
the NFC tag circuit is attached to the back surface and located to pass over the NFC reader of the user equipment to become temporarily powered to transmit the cover configuration data as the user equipment is slid between the side surfaces to the stored position.

7. The cover apparatus of claim 6, wherein:
the side surfaces are configured to receive a top of the user equipment to guide insertion of the user equipment to the stored position; and
the NFC tag circuit is attached adjacent to a bottom of the back surface to pass over the NFC reader located adjacent the top of the user equipment and become temporarily powered to transmit the cover configuration data and thereafter while the user equipment is in the stored position the NFC tag circuit is too remotely located from the NFC reader to become sufficiently powered by inductive coupling to signals emitted by the NFC reader to operate to transmit the cover configuration data.

8. The cover apparatus of claim 1, wherein:
the NFC tag circuit is configured to transmit a universal resource locator address as part of the cover configuration data that identifies a network node from which the user equipment can obtain the application which is configured to use the cover configuration data defining the location of the window in the front surface to configure information displayed in the second portion of the display device while the front surface covers the first portion of the display device.

9. The cover apparatus of claim 1, wherein:
the NFC tag circuit is configured to transmit a product code identifying the cover apparatus to enable the application executed by the processor of the user equipment to determine the location of the window in the front surface for configuring information displayed in the second portion of the display device while the front surface covers the first portion of the display device.

10. The cover apparatus of claim 1,
further comprising a conductive film on an adhesive layer, the conductive film extending across and electrically shorting an antenna of the NFC tag circuit to prevent the NFC tag circuit from being sufficiently powered by inductive coupling to signals emitted by the NFC reader to operate to transmit the cover configuration data,
wherein the conductive film is removable by a user to enable the NFC tag circuit to be sufficiently powered by inductive coupling to signals emitted by the NFC reader to operate to transmit the cover configuration data, and is re-attachable to the antenna by the user to prevent subsequent retransmission of the cover configuration data and associated interference with the NFC reader attempting to read other NFC tag circuits.

11. The cover apparatus of claim 1, wherein:
the NFC tag circuit comprises a charging circuit that accumulates power received through the inductive coupling to the NFC reader within the user equipment; and
the cover apparatus further comprises a user input interface powered by the charging circuit, user actuation of the user input interface causes the NFC tag circuit to be powered by the charging circuit to transmit a corresponding data signal to the NFC reader within the user equipment.

12. A user equipment comprising:
a housing that attaches to a cover apparatus;
a display device forms at least a portion of a front surface of the housing;
a near field communication (NFC) reader circuit that is configured to scan a NFC tag circuit of the cover apparatus through inductive coupling to obtain cover configuration data;
a processor coupled to the NFC reader circuit and the display device; and
a memory coupled to the processor and comprising computer readable program code that when executed by the processor causes the processor to perform operations comprising:
determining from the cover configuration data a location of a window in the cover apparatus that provides user viewing of a second portion of the display device while a first portion of the display device is covered by the cover apparatus preventing user viewing of the first portion of the display device; and
configuring information based on the determined location of the window in the cover apparatus for display in the second portion of the display device while the cover apparatus covers and prevents user viewing of the first portion of the display device.

13. The user equipment of claim 12, wherein the operations further comprise:
determining from the cover configuration data a size of the window, a shape of the window, and/or a location of the window in the cover apparatus; and
configuring the information based on the determined size, shape, and/or location of the window in the cover apparatus for display in the second portion of the display device while the front surface covers the first portion of the display device.

14. The user equipment of claim 12, wherein the operations further comprise:
displaying information only within the second portion of the display device while the cover apparatus covers the first portion of the display device.

15. The user equipment of claim 12, wherein the operations further comprise:
selecting a group of applications that are configured to display information within the second portion of the display device while the cover apparatus covers the first portion of the display device; and
displaying members of the selected group of applications to a user for selective execution.

16. The user equipment of claim 12, wherein the operations further comprise:
determining from the cover configuration data a location of another window in the cover apparatus that provides user viewing of a third portion of the display device while the first portion of the display device is covered by the cover apparatus preventing user viewing of the first portion of the display device; and
configuring other information based on the determined location of the other window in the cover apparatus for display in the third portion of the display device while the cover apparatus covers the first portion of the display device.

17. The user equipment of claim 12, wherein the operations further comprise:
identifying a universal resource locator address as part of the cover configuration data;
obtaining the application from a network node identified by the universal resource locator address; and
executing the application to use the cover configuration data defining the location of the window in the front surface to configure information displayed in the second portion of the display device while the front surface covers the first portion of the display device.

18. The user equipment of claim 12, wherein the operations further comprise:
obtaining a product code from the cover configuration data which identifies the cover apparatus; and
determining the location of the window in the front surface based on the product code.

19. The user equipment of claim 12, wherein:
the display device comprises a touch sensitive interface configured to output a location where a user touched the display device; and
the operations further comprise calibrating the determined location of the window in the cover apparatus based on sensing at least one location of a user touch within the second portion of the display device.

20. The user equipment of claim 19, wherein the operations further comprise:
calibrating the determined location of the window in the cover apparatus to not exclude any of a plurality of locations of user touches within the second portion of the display device.

21. The user equipment of claim 12, wherein:
the display device comprises a touch sensitive interface configured to output a location where a user touched the display device; and
the operations further comprise causing an application, which is generating the information for display in the second portion of the display device, to ignore any touch locations from the touch sensitive interface that are outside the second portion of the display device while the cover apparatus covers the first portion of the display device.

22. The user equipment of claim 12,
further comprising a camera device,
wherein the operations further comprise operating the camera device to scan an optical code, and determine at least a portion of the cover configuration data from the optical code.
